(19) United States
(12) Patent Application Publication
(10) Pub. No.: US 2011/0203526 A1
(43) Pub. Date: Aug. 25, 2011

(54) Integrated Aquarium and Small Animal Exhibit

(76) Inventor: Patrick F. Kilroy, Lake Elsinore, CA (US)

(21) Appl. No.: 12/712,220

(22) Filed: Feb. 25, 2010

(51) Int. Cl. A01K 63/00

(52) U.S. Cl. 119/246

(57) ABSTRACT

An integrated aquarium and small animal exhibit comprising an aquarium full of water and containing a completely submerged, transparent, air chamber display case that is supported by a cabinet, in which the submerged air chamber display case is accessible through openings in the floor of the aquarium and top of the cabinet. The air chamber display case is in fluid communication with the atmosphere and is utilized to exhibit air breathing small animals living in a portable small animal enclosure that may be concealed from view beneath the aquarium and enclosed by the cabinet.

### BACKGROUND OF THE INVENTION

This invention pertains to an article of manufacture in the field of animal husbandry. The present invention is an integrated aquarium and small animal exhibit for displaying and housing both aquatic animals and small pet animals, including hamsters, mice and gerbils. The objective of this type of hybrid system is to provide the illusion of viewing air breathing animals existing underwater with aquatic animals, while simultaneously providing for life support functions and ready access to the aquatic and air breathing animals being displayed. The present invention provides an integrated aquarium and small animal exhibit with advantageous features to enhance the visual display and environment for the small animals, as well as to simplify maintenance and access for the user.

Prior art for combined aquarium and terrarium systems often attempted to provide a completely submerged terrarium providing all the life support functions for the air breathing animals from its location directly inside the aquarium. For example, U.S. Pat. No. 4,958,593 to Hurlburt, utilized such a design. The shortcoming of this design is inadequate access to the terrarium to provide life support functions, such as food, water, cleaning and care for the air breathing animals. In addition, by placing the terrarium directly inside the aquarium it limits the functionality required to provide for the proper well being and care of the wide assortment of terrestrial animals proposed to live in the singular type of terrarium housing.

Prior art for small animal enclosures or habitat systems have been used and enjoyed for many years by pet enthusiasts; for example U.S. Pat. Nos. 3,791,346; 3,865,082; 5,186,122 and 5,664,524. Small animal enclosures or habitat systems utilize modular, self-contained, semi-transparent, enclosures and accessories that are connected to tubular members by rings or couplings. The tubular members simulate the tunneling behavior of the small animals. The tubular members are composed of standardized sections for construction of the artificial tunneling system and allows expansion from one enclosure or accessory to another. A good example of an animal path connecting system is presented by U.S. Pat. No. 3,859,961 granted to Willinger et al. in 1975. These types of small animal enclosures and connecting systems have been used to connect a variety of enclosures and a wide assortment of accessories. However, prior art for such small animal enclosures or habitat systems have failed to improve the art into the field of aquariums.

Prior art attempts to combine an aquarium and animal observation system into a single unit resulted in limited versatility and precluded the rearrangement of the fixed animal observation system. For example, U.S. Pat. No. 6,019,064 to Alarcon provides non-transparent small animal enclosures that rely upon the permanent connection with the aquarium to function.

Prior art has often failed to maintain the illusion of viewing air breathing animals existing underwater in the aquarium by showing the viewer an intuitive access point to the air breathing animal and source of air from the atmosphere. This imperfection is evident in U.S. Pat. Nos. D251,206 to Conrad, 6,019,064 to Alarcon and 4,958,593 to Hurlburt. To quote Hurlburt's design, the . . . “legs, supporting the vivarium and spacing the bottom wall of the vivarium apart from the supporting surface, for easy access into the inside of the terrarium through the access opening”. Hurlburt's design diminishes the illusionary objective by clearly showing the method of access and source of air to the submerged terrarium from the space in between the vivarium and supporting legs.

Prior art lacks the utility to maintain the illusionary objective of viewing air breathing small animals existing underwater, while simultaneously providing for the ready access and proper well being of the air breathing small animals.

It is an object of the present invention to maintain the illusion of viewing air breathing small animals existing underwater in an aquarium by providing a completely submerged air chamber display case within the aquarium to allow aquatic animals to move around and over the top of the air breathing animals contained therein.

It is a further object of the invention to provide an external, self-contained and modular small animal enclosure that is accessible to the air chamber display case and is purposefully designed for housing air breathing small animals being displayed to facilitate care, access and well being of the animal.

It is a further object of the preferred embodiment of the invention to foster the illusion of viewing air breathing animals existing underwater in an aquarium by concealing the access opening to the air chamber display case displaying the air breathing small animals contained therein.

It is a further object of the invention to provide a structural support system for the aquarium and small animal enclosure to organize the arrangement of the exhibit, enhance the visual effects and facilitate maintenance.

It is a further object of the invention to provide a means for quickly connecting and disconnecting the small animal enclosure that leads to the air chamber display case.

These and other objects of the present invention will become better understood from the detailed description which follows.

### BRIEF SUMMARY OF THE INVENTION

The present invention resolves the problems of prior art by utilizing key elements in a manner to foster the illusion of viewing a small animal existing underwater in an aquarium, while simultaneously providing for life support functions, ease of maintenance and ready access to the aquatic and small animals being exhibited. The invention comprises a substantially transparent aquarium full of water, containing a completely submerged, substantially transparent, air chamber display case connected to the bottom floor of the aquarium and is water tight. The aquarium contains an opening in the bottom floor to allow access to the air chamber from below. The aquarium is supported by a cabinet, in which the bottom of the aquarium is in contact with the top of the cabinet. The submerged air chamber display case is accessible by the air breathing small animal through an opening in both the floor of the aquarium and top of the cabinet. The access openings in the bottom floor of the aquarium and top of the cabinet are large enough to permit access by the human hand.

Air breathing small animals live in a separate, self-contained, small animal enclosure that is external to the aquarium and concealed from view beneath the aquarium and enclosed by the cabinet. The small animal enclosure is specifically designed for small animals, including hamsters, mice, gerbils and similar small animals. The small animal enclosure is self-contained and provides life support functions for the animal, including a location for food, water and bedding.

A modular and semi-transparent tubular conduit system connects the small animal enclosure to a flange that leads to the air chamber display case and provides a means for the air breathing small animal to travel through the tubular conduit system from the small animal enclosure to the submerged air chamber display case above. The tubular conduit system is modular and each tubular member may be readily connected together and disconnected by the use of releasable couplings.

The tubular conduit system is coupled to a removal flange. The flange is connected to the underside of the top of the cabinet and positioned over the access opening of the cabinet to the air chamber display case. The flange has an inner opening that is smaller than the access opening in the aquarium floor, as well as smaller than the access opening in the top of the cabinet. The flange allows a small animal to pass through the inner opening in the flange, while the larger plug of the flange temporarily closes the remaining portion of the access opening of the aquarium and cabinet to the air chamber display case to prevent the escape of the small animal. The flange may be easily removed to completely expose the access opening and allow the user access by hand to the air chamber display case to facilitate periodic maintenance. Whenever the portable small animal enclosure and tubular conduit system are uncoupled from the flange, the opening at the end of the tubular conduit system may be temporarily closed by coupling with an end cap.

The enclosed cabinet facilitates the illusionary objective of viewing air breathing animals existing underwater by denying viewers a readily perceived source of air exchange. In addition, the cabinet organizes the exhibit to enhance the display and facilitate maintenance. Access to the entire small animal enclosure by the user is provided by a door on the front of the cabinet. To increase visual observation for the pet owner, the front cabinet door may remain normally open and then closed when exhibiting.

### BRIEF DESCRIPTION OF THE SEVERAL VIEWS OF THE DRAWING

FIG. 1 is a perspective view of the subject invention;

FIG. 2 is a front view of FIG. 1;

FIG. 3 is a front view of FIG. 1 showing the cabinet's access door open to reveal the small animal enclosure contained therein, along with the interior position of the flange;

FIG. 4 is a perspective view of the cabinet;

FIG. 5 is a right side view of FIG. 1;

FIG. 6 is a front view of the flange;

FIG. 7 is a sectional view of FIG. 1;

FIG. 8 is a perspective view of another preferred embodiment of the subject invention showing a bow front shaped aquarium, enclosed cabinet and air chamber display case.

### DETAILED DESCRIPTION OF THE INVENTION

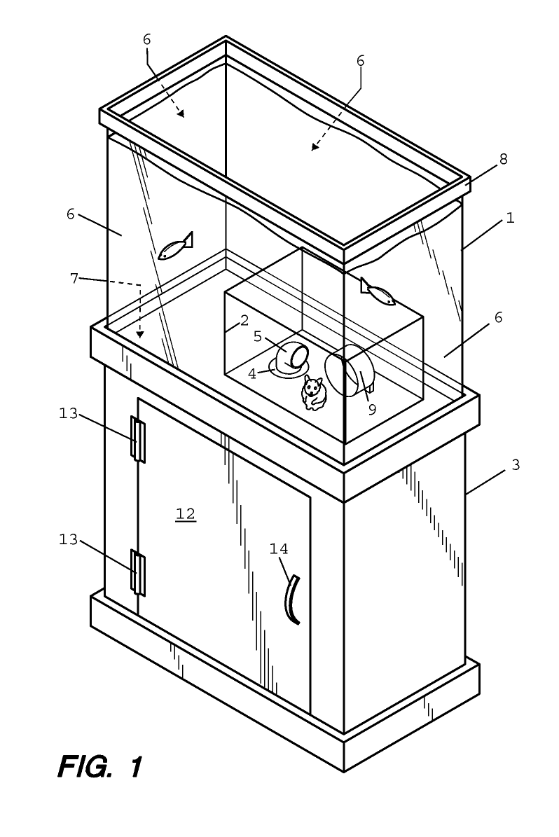

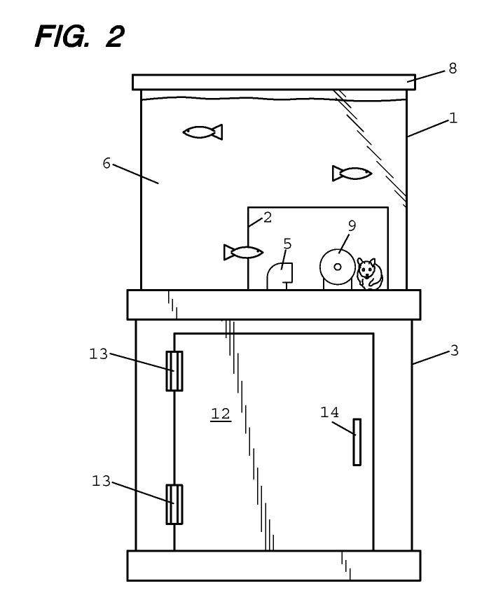

The preferred embodiment of the present invention of the integrated aquarium and small animal exhibit comprises an aquarium containing a completely submerged air chamber display case mounted on top of an enclosed cabinet; inside the enclosed cabinet is a self-contained and portable small animal enclosure. With reference to the drawings and particularly FIGS. 1, 2, and 3, the aquarium 1 is made of substantially transparent plastic or glass material. Upright walls 6 and a bottom floor part 7 are joined by adhesive to form the aquarium 1. The top of the aquarium 1 is substantially open, as shown in FIG. 1; however, the upper and bottom edges of the walls may be additionally joined by a frame 8 to provide structural support. The frame can have an angle or channel to accept a cover or light fixture, as is well known in the aquarium art. The aquarium 1 is made to be completed filled with water and house aquatic animals. The aquarium 1 has an access opening in the bottom floor part 7 that is large enough to accommodate the human hand.

Inside the aquarium 1 is an air chamber display case 2 made of substantially transparent plastic or glass material. Upright walls in cooperation with a top part and aquarium's bottom floor part 7 are joined to form the air chamber display case 2. The access opening in the bottom floor part 7 of the aquarium 1 is contained within the bounds of the air chamber display case 2. The air chamber display case 2 is in fluid communication with the atmosphere and is water tight. The air chamber display case 2 is used to display a small animal, such as hamsters, mice and gerbils. The air chamber display case may house pet toys, such as an exercise wheel 9. The size of the said access opening in the aquarium's bottom floor 7 is large enough to accommodate the human hand and may be co-extensive within the bounds of the air chamber display case 2. The access opening provides continuous atmospheric air exchange to the air chamber display case 2, as well as access for the small animal and pet owner.

The dimensions of the air chamber display case 2 are smaller than the aquarium 1, thereby creating a space for housing aquatic animals, such as fish, and for displaying artificial aquarium décor. The air chamber display case 2 is completely submerged underwater to allow aquatic animals to move over the top. A space is maintained between the air chamber display case 2 and interior walls of the aquarium 1, which allow aquatic animals room to move around all sides of the air chamber display case 2.

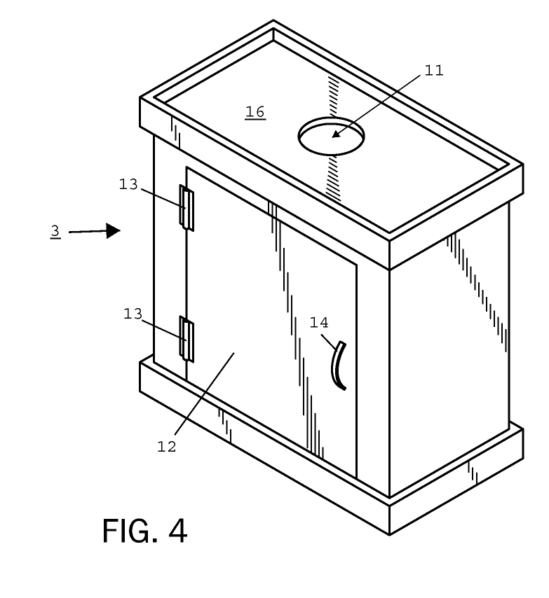

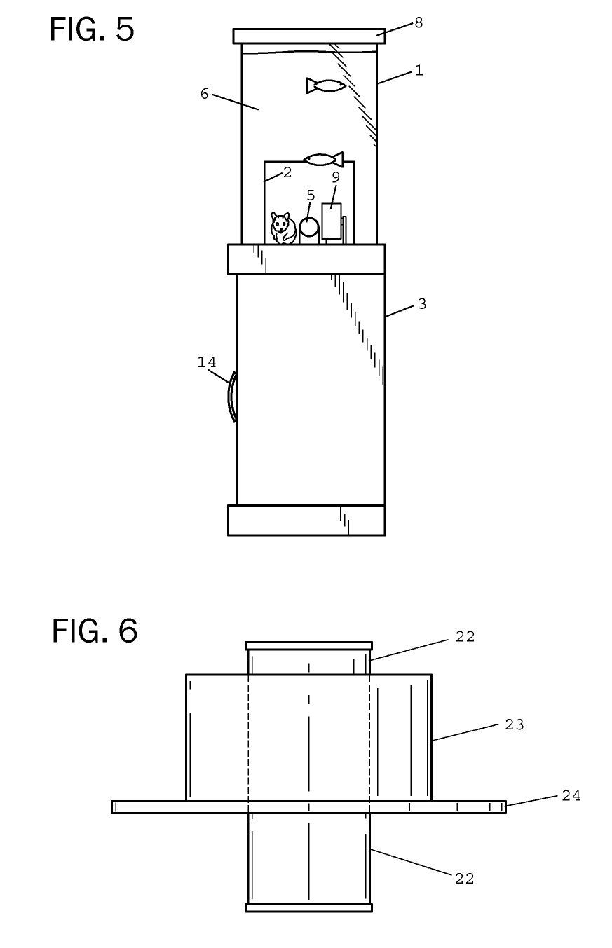

The combined aquarium 1 and air chamber display case 2 are supported by an enclosed cabinet 3. The top of the enclosed cabinet 3 has an opening 11, as shown in FIG. 4, which is equal or larger than the access opening in the aquarium floor. The bottom of the aquarium 1 is in contact with the top part 16 of the enclosed cabinet 3, so that the aquarium 1 covers the opening 11 in the top part 16 of the enclosed cabinet 3. The access opening in the bottom floor 7 of the aquarium 1 is aligned with the opening 11 in the top part 16 of the enclosed cabinet 3 to permit access from underneath the enclosed cabinet 3 to the air chamber display case 2. The front of the enclosed cabinet 3 has an access door 12, with hinges 13, to permit access to the contents inside. The access door 12 to the enclosed cabinet 3 has a handle 14 on the outside to facilitate opening. The enclosed cabinet 3 contains an adjustable shelf 15 inside for use as a platform to support a small animal enclosure 10. The enclosed cabinet 3 may also be used to house aquarium support systems, such as filters, air pumps and supplies.

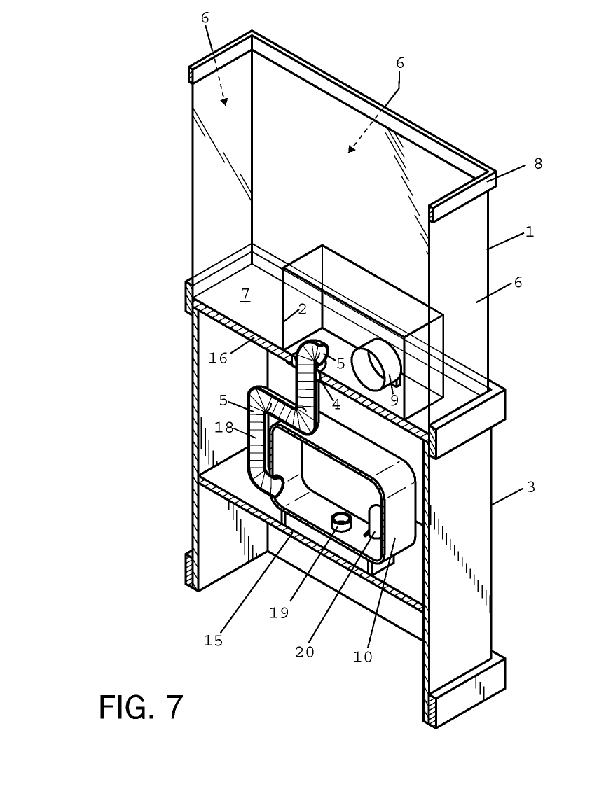

Beneath the combined aquarium 1 and air chamber display case 2, and contained inside the cabinet 3, is a small animal enclosure 10. The small animal enclosure 10 is designed for small pet animals, including hamsters, mice, gerbils and similar small animals. In reference to FIG. 7, the small animal enclosure 10 is fully self-contained to provide care for the animal, including containers for food 19 and water 20. The small animal enclosure 10 is made of a combination of substantially transparent plastic and wire cage material. The small animal enclosure has a hinged door 21 on the front.

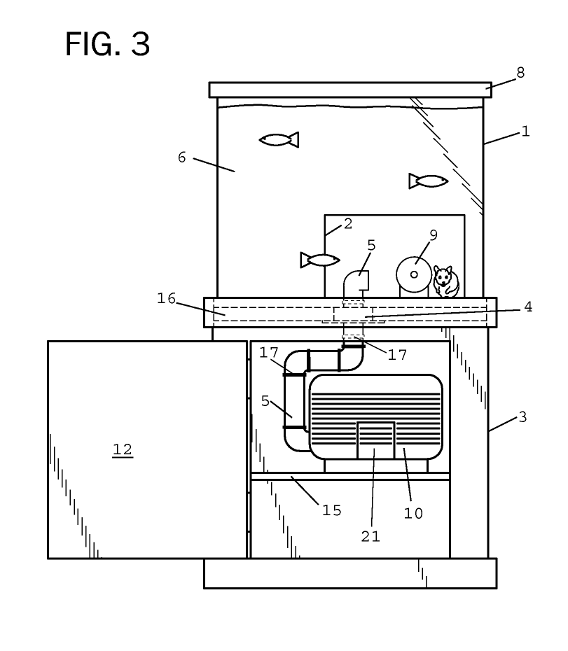

In reference to FIGS. 3 and 7, a modular and semi-transparent tubular conduit system connects the small animal enclosure 10 to the air chamber display case 2. The tubular conduit system consist of sectional tubular members 5 connected by releasable couplings 17. The tubular members 5 contain ribs 18 on the inside to assist the small animal with climbing. The tubular conduit system provides a means for the air breathing small animal to travel through the tubular conduit system from the portable small animal enclosure 10 to the submerged air chamber display case 2. The tubular conduit system is modular and may be readily connected and disconnected by the use of releasable couplings 17 to other tubular members 5, enclosures and accessories.

The tubular conduit system is coupled to a removal flange 4 by releasable couplings 17, as shown in FIGS. 3, 6 and 7. The flange 4 is connected to the underside of the top part 16 of the cabinet 3 and is positioned over the access openings of the cabinet 3 and aquarium 1 to the air chamber display case 2. The flange 4 has an inner conduit 22 that is smaller than the access opening 11 in the top part 16 of the cabinet 3 and aquarium floor 7. The flange 4 allows a small animal to pass through the inner conduit 22 of the flange 4, while the larger plug 23 of the flange 4 temporarily closes the remaining portion of the access openings to the aquarium 1, cabinet 3 and air chamber display case 2 to prevent the escape of the small animal. The plate 24 of the flange 4 is larger than the access opening in the aquarium 1 and cabinet 3. The flange 4 may be easily removed to completely expose the access openings and allow the user access to the air chamber display case 2 to facilitate periodic maintenance.

Access to the entire small animal enclosure 10 by the user is provided by an access door 12 with hinges 13 on the front of the cabinet 3. To provide for the well being of the animal, the front cabinet door 12 may remain normally open and then closed when exhibiting. The small animal enclosure 10 may also be temporarily moved and placed at another location to provide versatility to the user and variety of scenery to the small animal. Whenever the portable small animal enclosure 10 and tubular conduit system are uncoupled from the flange 4, the opening at the end of the tubular conduit system may be temporarily closed by coupling with an end cap.

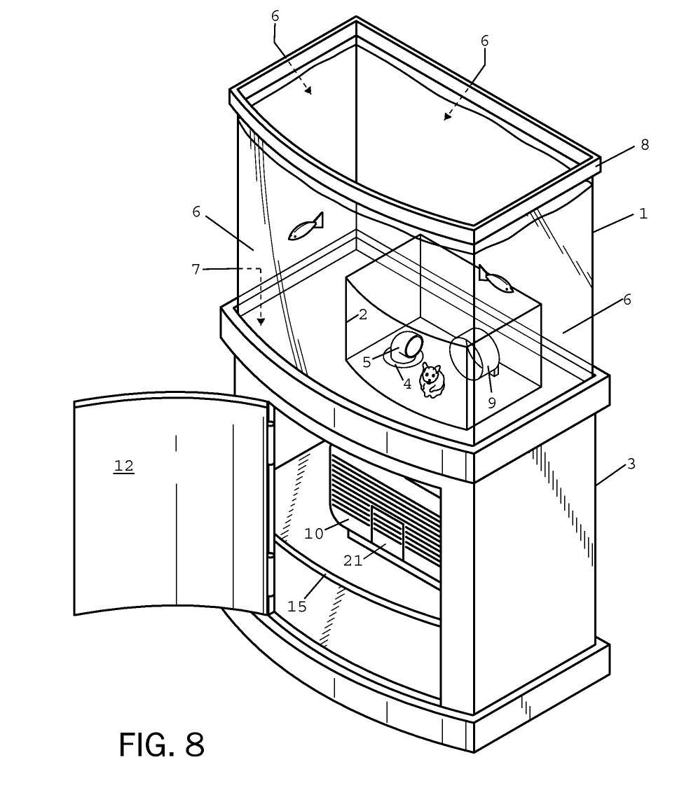

FIG. 8 shows another preferred embodiment of the subject invention. This embodiment comprises a bow front shaped aquarium 1, enclosed cabinet 3 and air chamber display case 2.

One or more walls of the aquarium 1 may be straight, as shown in FIG. 1 or curved, as shown in FIG. 8. Similarly, one or more walls of the air chamber display case 2 may be straight, as shown in FIG. 1 or curved, as shown in FIG. 8. The walls of the aquarium 1 or air chamber display case 2 may be joined by adhesive to form a water tight seal or the walls may be molded and continuous around bends. Although the upper and bottom edges of the walls in FIGS. 1 and 8 are depicted with a frame 8, the frame is not always necessary, especially for rimless glass aquarium construction. Even though the walls of the aquarium 1 and air chamber display case 2 are upright, the walls need not be substantially vertical or planar. Therefore, the walls can have any shape or orientation, as is well known in the aquarium art.

The preferred embodiment of the present invention for an article of manufacture has been described herein for exemplary purposes, and of the manner and process of making and using it, in such full, clear, concise and exact terms as to enable any person skilled in the art to which it pertains to make and use this invention. This invention is, however, subject to modifications and alternate constructions from that described, which are fully equivalent. For example, an open stand design may be an alternative to the enclosed cabinet. The open stand design may be desired by users, especially if the invention becomes renowned. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention.

What I claim as my invention is:

1. An article of manufacture comprising:
a. a substantially transparent aquarium full of water that is used to house aquatic animals;
b. connected to the bottom floor of the aquarium is a completely submerged, substantially transparent, air chamber display case;
c. an access opening in the shared bottom floor of the aquarium and air chamber display case is provided to access the air chamber display case, with the air chamber display case being in fluid communication with the atmosphere, the access opening is large enough to accommodate the human hand and may be co-extensive within the bounds of the air chamber display case;
d. the aquarium is supported by a cabinet, the top of the cabinet has an access opening that is large enough to accommodate the human hand and may be co-extensive within the bounds of the aquarium's bottom floor, the access opening in the cabinet is aligned with the said access opening in the aquarium floor to permit access to the air chamber display case from below;
e. the enclosed cabinet has a door on the front that permits ready access to the contents inside;
f. the submerged air chamber display case is accessible to small air breathing animals living in a separate, portable, small animal enclosure that may be concealed from view beneath the aquarium and enclosed by the cabinet, the small animal enclosure is self-contained, with containers for food and water; and
g. small animals can freely travel from the small animal enclosure to the submerged air chamber display case through a semi-transparent tubular conduit system, the tubular conduit systems is comprised of sectional tubular members connected by releasable couplings.

2. The article of manufacture of claim 1, further comprising a flange that has an inner conduit that connects to the said tubular conduit system, with the flange having an external plug that temporarily closes the access openings to the air chamber display case, while allowing a small animal to pass through the center of the flange from the small animal enclosure to the air chamber display case.

3. An article of manufacture comprising:
a. substantially transparent upright walls in cooperation with a bottom part form an aquarium, the aquarium is full of water and used to house aquatic animals;
b. substantially transparent upright walls in cooperation with a top part form a container that is joined to the bottom floor of the aquarium to form an air chamber display case, the air chamber display case is made to be completely submerged underwater within the aquarium;
c. an access opening in the shared bottom floor of the aquarium and air chamber display case is provided to access the air chamber display case from below, with the air chamber display case being in fluid communication with the atmosphere, where in the access opening is large enough to accommodate the human hand and may be co-extensive within the bounds of the air chamber display case, with the air chamber display case used to exhibit small animals;
d. the aquarium is supported by a cabinet, the top of the cabinet has an access opening that is large enough to accommodate the human hand and may be co-extensive within the bounds of the aquarium's bottom floor, the access opening in the cabinet is aligned with the said access opening in the aquarium floor to permit access to the air chamber display case from below;
e. the enclosed cabinet has a door on the front that permits ready access to the contents inside;
f. the submerged air chamber display case is accessible to small air breathing animals living in a separate, portable, small animal enclosure that may be concealed from view beneath the aquarium and enclosed by the cabinet, the small animal enclosure is self-contained, with containers for food and water; and
g. small animals can freely travel from the small animal enclosure to the submerged air chamber display case through a semi-transparent tubular conduit system, the tubular conduit systems is comprised of sectional tubular members connected by releasable couplings.

4. The article of manufacture of claim 3, further comprising a flange that has an inner conduit that connects to the said tubular conduit system, with the flange having an external plug that temporarily closes the access openings to the air chamber display case, while allowing a small animal to pass through the center of the flange from the small animal enclosure to the air chamber display case.
